(19) United States
(12) Patent Application Publication
(10) Pub. No.: US 2003/0220113 A1
(43) Pub. Date: Nov. 27, 2003

(54) Portable terminal equipment and mobile communication system

(75) Inventor: Toshiyuki Oda, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/434,979

(22) Filed: May 9, 2003

(30) Foreign Application Priority Data
May 23, 2002 (JP) 2002-149137

(51) Int. Cl. H04Q 7/20

(52) U.S. Cl. 455/446; 455/456.5; 455/441

(57) ABSTRACT

This invention relates to a mobile communication system having a plurality of radio base stations which respectively form cells/sectors and communicate with mobile units existing in the cells/sectors. A mobile unit transmits, to a radio base station, information by which the position of the mobile unit can be estimated. A radio base station estimates the shape of a cell/sector formed by the radio base station on the basis of information transmitted from a mobile unit. If this system further includes a higher rank station which connects radio base stations, reporting the shape of a cell/sector estimated by a radio base station to the higher rank station will allow a plurality of radio base stations to share the shape of the cell/sector.

### BACKGROUND OF THE INVENTION

1. Field of the Invention

The present invention relates to a mobile communication system having mobile units and a plurality of radio base stations which respectively form cells/sectors and perform communications with mobile units existing in the cells/sectors.

2. Description of the Prior Art

FIG. 1 shows an example of the arrangement of a mobile communication system that forms a cell/sector arrangement.

As shown in FIG. 1, one cell 140 is formed by one radio base station 120, and a plurality of sectors 150a to 150f are formed in the cell 140. Note that the CDMA scheme generally uses a scheme of realizing the sectors 150a to 150f by using different scrambling codes at the same frequency.

FIG. 2 shows a state wherein a plurality of (three) radio base stations 120, each identical to the one shown in FIG. 1, are arranged adjacent to each other.

As shown in FIG. 2, in practice, a plurality of cells 140a to 140c respectively formed by a plurality of radio base stations 120a to 120c are so arranged as to overlap each other. Overlap zones are formed in the overlapping portions.

FIG. 3 shows the actual shapes of the sectors 150a to 150f and cell 140 formed by the radio base station 120 shown in FIG. 1.

As shown in FIG. 3, the actual shapes of the sectors 150a to 150f become complex depending on geographic features, buildings, and atmospheric conditions, and hence the shape of the cell 140 is not perfectly circular. For this reason, the place where a mobile unit needs to perform a cell/sector handoff varies depending on situations.

In general, in a mobile communication system, a mobile unit performs intermittent reception in a standby state to reduce power consumption. When the mobile unit moves between cells/sectors, the mobile unit must communicate with a radio base station for the sake of a cell/sector handoff procedure.

FIG. 4 is a view for explaining a cell/sector handoff procedure in a conventional mobile communication system.

As shown in FIG. 4, when a mobile unit 110 moves between two cells 140a and 140b, the unit needs to communicate with a radio base station to execute a cell handoff procedure in a cell/sector handoff procedure interval which is an overlapping zone between the two cells 140a and 140b.

The mobile unit 110 therefore needs to carry out peripheral level measurement for each intermittent reception in intermittent reception intervals 161a and 161b in order to determine this handoff. This leads to an increase in power consumption and a reduction in standby time.

### SUMMARY OF THE INVENTION

The present invention has been made in consideration of the above situation in the prior art, and has as its object to provide a mobile communication system which has a cell/sector arrangement and can reduce the power consumption of mobile units.

In order to achieve the above object, according to the first aspect of the present invention, there is provided a mobile communication system including mobile units and a plurality of radio base stations which respectively form cells/sectors and communicate with the mobile units existing in the cells/sectors, wherein the radio base station estimates a shape of the cell/sector formed by the radio base station on the basis of information transmitted from the mobile unit.

According to the second aspect of the present invention, there is provided a mobile communication system wherein the mobile unit described in the first aspect transmits, to the radio base station, information by which a position of the mobile unit can be estimated.

According to the third aspect of the present invention, there is provided a mobile communication system wherein the radio base station described in the first aspect registers the position of the mobile unit on the basis of information transmitted from the mobile unit.

According to the fourth to sixth aspects of the present invention, there is provided a mobile communication system described in each of the first to third aspects, which further comprises a higher rank station which connects the plurality of radio base stations to each other, the radio base stations reporting the estimated shapes of the cells/sectors to the higher rank station.

According to the seventh to ninth aspects of the present invention, there is provided a mobile communication system described in each of the fourth to sixth aspects, wherein the radio base station includes a hysteresis width in the shape of the cell/sector.

According to the 10th to 12th aspects of the present invention, there is provided a mobile communication system described in each of the second, fifth, and eighth aspects, wherein the radio base station estimates a shape of a cell/sector formed by the radio base station on the basis of a code determined for each of the sectors, which is transmitted from the mobile unit, and a reception level of the code.

According to the 13th to 15th aspects of the present invention, there is provided a mobile communication system described in each of the second, fifth, and eighth aspects, wherein the radio base station estimates a shape of a cell/sector formed by the radio base station on the basis of a transmission attenuation amount of a pilot channel in the mobile unit which is transmitted from the mobile unit.

According to the 16th to 18th aspects of the present invention, there is provided a mobile communication system described in each of the second, fifth, and eighth aspects, wherein the mobile unit estimates a position of the mobile unit on the basis of power control information transmitted from the radio base station, and transmits the position information to the radio base station, and the radio base station estimates a shape of a cell/sector formed by the radio base station on the basis of position information transmitted from the mobile unit.

According to the 19th to 21st aspects of the present invention, there is provided a mobile communication system described in each of the fourth to sixth aspects, wherein the radio base station acquires a shape of a cell/sector reported to the higher rank station, and provides the acquired shape of the cell/sector to the mobile unit.

According to the 22nd to 24th aspects of the present invention, there is provided a mobile communication system described in each of the fourth to sixth aspects, wherein the mobile unit determines a frequency of processing to be performed when the mobile unit moves between cells/sectors on the basis of the shapes of the cells/sectors provided from the radio base station.

According to the 25th to 27th aspects of the present invention, there is provided a mobile communication system described in each of the fourth to sixth aspects, wherein the mobile unit decreases a time and cycle for processing to be performed when the mobile unit moves between cells/sectors on the basis of the shapes of the cells/sectors provided from the radio base station.

According to the 28th to 30th aspects of the present invention, there is provided a mobile communication system described in each of the fourth to sixth aspects, wherein the mobile unit decreases a time and cycle for processing to be performed when the mobile unit moves between cells/sectors, when determining that the mobile unit is moving at a constant velocity.

According to the 31st to 34th aspects of the present invention, there is provided a mobile communication system described in each of the 19th, 22nd, 25th, and 28th aspects, wherein the mobile unit provides a shape of a cell/sector, provided from the radio base station, to another mobile unit.

According to the 35th to 37th aspects of the present invention, there is provided a mobile communication system described in each of the seventh to ninth aspects, wherein the hysteresis width is variable.

According to the 38th to 40th aspects of the present invention, there is provided a mobile communication system described in each of the 35th to 37th aspects, wherein the variable hysteresis width is determined from variable data based on a season, temperature, or time and invariable data including topographical data.

According to the 41st to 43rd aspects of the present invention, there is provided a mobile communication system described in each of the 38th to 40th aspects, wherein the invariable data is determined while including special information indicating that the mobile unit is located in a building or underground.

According to the 44th to 46th aspects of the present invention, there is provided a mobile communication system described in each of the seventh to ninth aspects, wherein the radio base station increases the hysteresis width under a condition in which fading tends to occur.

As is obvious from the respective aspects, according to the present invention, radio base stations estimate the shapes of the cells/sectors formed by the radio base stations on the basis of information transmitted from mobile units, and provide the shapes of the cells/sectors to the mobile units. If a mobile unit simplifies the processing to be performed when moving between cells/sectors on the basis of the estimated shapes of the cells/sectors, the power consumption of the mobile unit can be reduced.

In addition, if a mobile unit estimates its position in standby state on the basis of only information received from a radio base station, the power consumption of the mobile unit can be reduced.

The above and many other objects, features and advantages of the present invention will become manifest to those skilled in the art upon making reference to the following detailed description and accompanying drawings in which preferred embodiments incorporating the principle of the invention are shown by way of illustrative examples.

### BRIEF DESCRIPTION OF THE DRAWINGS

FIG. 1 is a schematic view showing an example of the arrangement of a mobile communication system having a cell/sector arrangement;

FIG. 2 is a schematic view showing a state wherein a plurality of (three) radio base stations, each identical to the one shown in FIG. 1, are arranged adjacent to each other;

FIG. 3 is a view for explaining the shapes of sectors and cell which are actually formed by a radio base station like the one shown in FIG. 1;

FIG. 4 is a view for explaining a cell/sector handoff procedure in a conventional mobile communication system;

FIG. 5 is a schematic view showing the arrangement of a mobile communication system according to an embodiment of the present invention;

FIG. 6 is a block diagram showing the arrangement of a mobile unit in FIG. 5;

FIG. 7 is a block diagram showing the arrangement of a radio base station in FIG. 5;

FIG. 8 is a schematic view for explaining information transmission from mobile units to a radio base station which exist in a cell in the mobile communication system shown in FIG. 5;

FIG. 9 is a view showing the cell map formed by a radio base station in the mobile communication system in FIG. 5;

FIG. 10 is a view for explaining a hysteresis zone in the cell map shown in FIG. 9;

FIG. 11 is a view for explaining processing to be performed when a mobile unit moves between the cells formed by radio base stations in the mobile communication system shown in FIG. 5;

FIG. 12 is a view for explaining a method of estimating the position of a mobile unit in the mobile communication system shown in FIG. 5;

FIG. 13 is a view for explaining another method of estimating the position of a mobile unit in the mobile communication system shown in FIG. 5;

FIG. 14 is a view for explaining the peripheral level measurement processing performed by a mobile unit in the mobile communication system shown in FIG. 5;

FIG. 15 is a view for explaining the processing to be performed when a mobile unit moves at a nearly constant velocity in the mobile communication system shown in FIG. 5; and

FIG. 16 is a view for explaining the processing to be performed when an ad-hoc system with low power consumption is mounted in a mobile unit in the mobile communication system shown in FIG. 5.

### DETAILED DESCRIPTION OF THE PREFERRED EMBODIMENTS

Several preferred embodiments of the present invention will be described below with reference to the accompanying drawings.

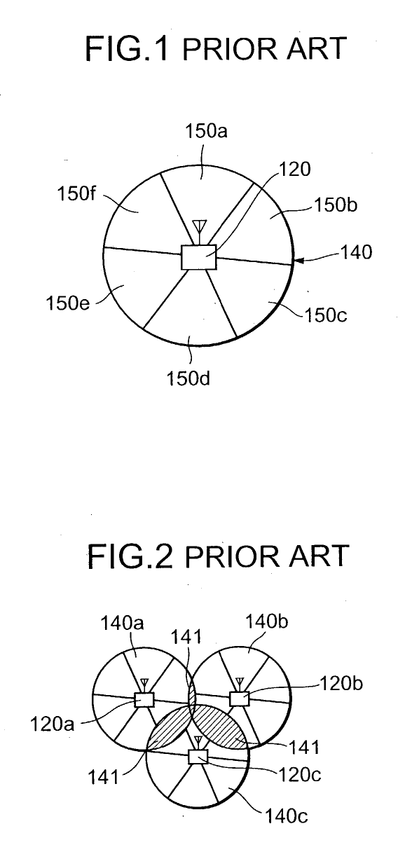

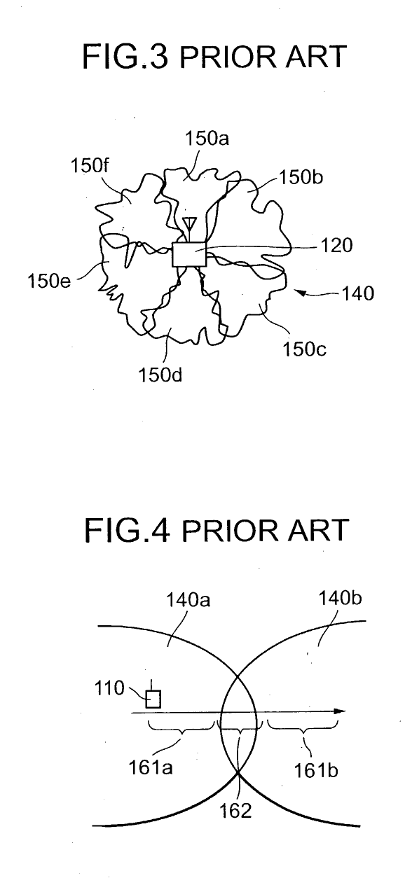

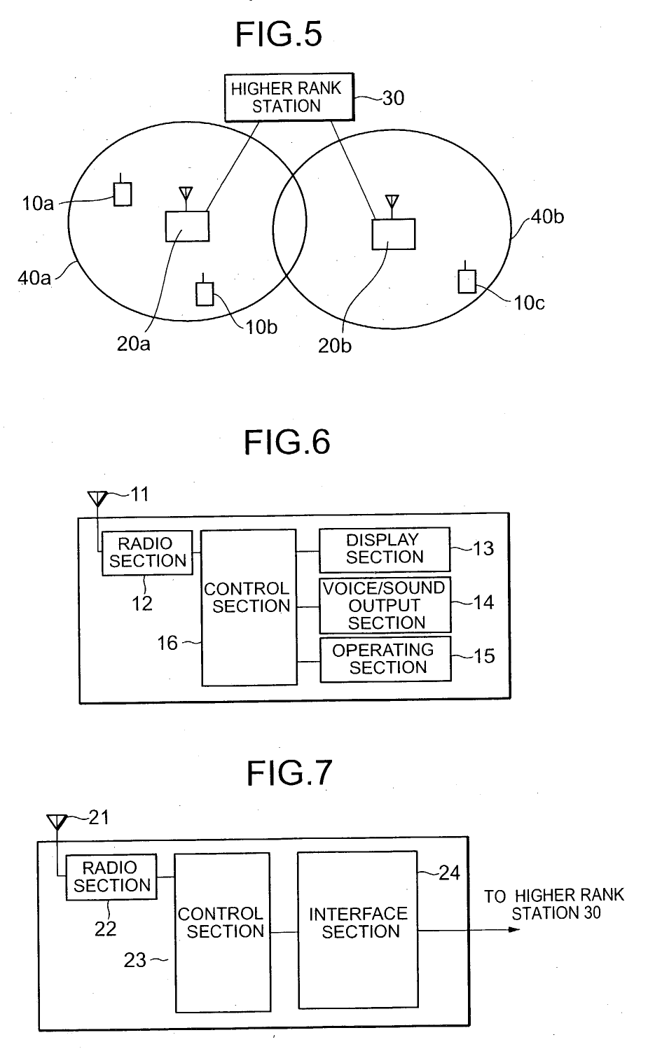

As schematically shown in FIG. 5, a mobile communication system according to an embodiment of the present invention is comprised of mobile units 10a to 10c, radio base stations 20a and 20b which respectively form cells 40a and 40b, communicate with the mobile units 10a to 10c existing in the cells 40a and 40b, and estimate the shapes of the cells 40a and 40b on the basis of information transmitted from the mobile units 10a to 10c, and a higher rank station 30 which connects the radio base stations 20a and 20b to each other. The mobile units 10a to 10c determine processing frequencies in moving between the cells 40a and 40b on the basis of the shapes of the cells 40a and 40b which are estimated by the radio base stations 20a and 20b. Note that a plurality of sectors are formed in the cells 40a and 40b as in those shown in FIG. 1. Although FIG. 5 shows only the three mobile units 10a to 10c and the two radio base stations 20a and 20b, the numbers of mobile units and radio base stations are not limited to these.

As shown in FIG. 6, each of the mobile units 10a to 10c in this embodiment is constituted by an antenna 11 for transmitting/receiving information between the radio base stations 20a and 20b, a radio section 12 which modulates/demodulates information transmitted/received through the antenna 11, a display section 13 such as a display which displays information, a voice/sound output section 14 such as a speaker which outputs voice information, a buzzer sound, and the like, an operating section 15 for externally inputting information, and a control section 16 which controls the radio section 12, display section 13, voice/sound output section 14, and operating section 15 and determines a processing frequency in moving between the cells 40a and 40b on the basis of the shapes of the cells 40a and 40b which are estimated by the radio base stations 20a and 20b.

As shown in FIG. 7, each of the radio base stations 20a and 20b in this embodiment is constituted by an antenna 21 for transmitting/receiving information between the mobile units 10a to 10c, a radio section 22 which modulates/demodulates information transmitted/received through the antenna 21, an interface section 24 serving as an interface means for the higher rank station 30, and a control section 23 which controls the radio section 22 and interface section 24, and estimates the shapes of the cells 40a and 40b on the basis of information transmitted from the mobile units 10a to 10c.

Processing in the mobile communication system having the above arrangement will be described below.

The mobile units 10a to 10c transmit the codes of sectors that can be measured in places where they presently exist and the measurement results of various levels (RSSI, RSCP, Ec/No, and the like) to the radio base stations 20a and 20b. If the mobile units 10a to 10c have position information of the mobile units 10a to 10c, they transmit this position information to the radio base stations 20a and 20b.

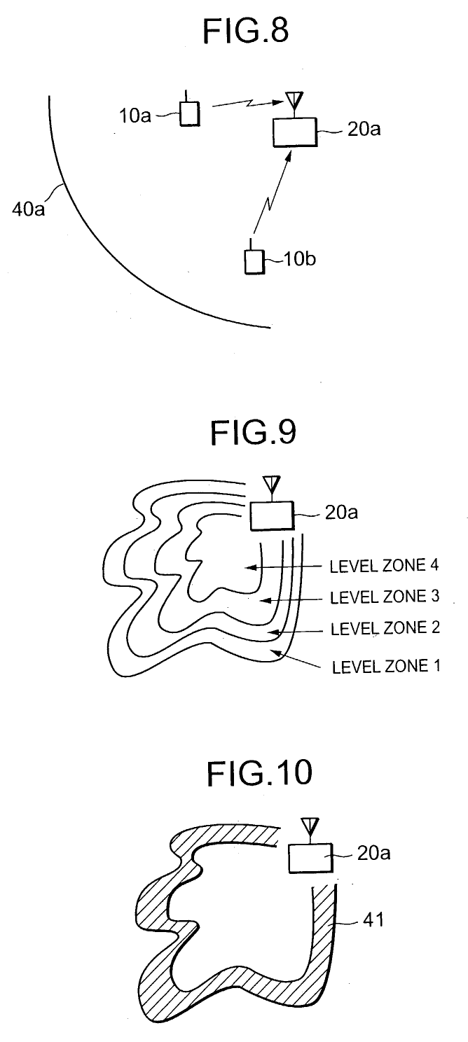

Information transmission from the mobile units 10a and 10b existing in the cell 40a to the radio base station 20a in the mobile communication system according to the present invention will be described with reference to FIG. 8.

The mobile units 10a and 10b existing in the cell 40a transmit, to the radio base station 20a, the codes of sectors that can be measured in the places where the mobile units 10a and 10b presently exist and the measurement results of various levels (RSSI, RSCP, Ec/No, and the like).

The radio base stations 20a and 20b estimate the positions of the mobile units 1a to 10c on the basis of information transmitted from the mobile units 10a to 10c, and also estimate the shapes of the cells 40a and 40b on the basis of the estimated position information and the reception levels of signals from the mobile units 10a to 10c, thereby forming a cell map indicating the shape of the cells 40a and 40b.

FIG. 9 shows the cell map formed by the radio base station 20a in the mobile communication system according to the present invention.

The radio base station 20a forms a cell map constituted by a plurality of level zones corresponding to the reception levels in the mobile units 10a and lob. Assume that when the mobile unit enters level zone 1 in FIG. 9, the unit can receive stronger radio waves from another sector. In this case, a handoff procedure is executed.

In order to prevent redundant control operation, level zone 1 exhibiting the minimum reception level is regarded as a hysteresis zone.

The hysteresis zone in the cell map shown in FIG. 9 will be described with reference to FIG. 10.

In the cell map shown in FIG. 9, level zone 1 is regarded as a hysteresis zone 41. Assume that control is performed such that when the mobile units 10a and 10b exist outside level zone 1, a handoff procedure is executed, and no return occurs unless the mobile units 10a and 10b enter level zone 2.

Note that the width of the hysteresis zone 41 is not constant, but based on invariable data including topographic data and variable data such as atmospheric conditions (seasons, temperature, time, and the like) and geographical conditions. This width can be changed by changing this variable data. For example, conditions of temperature/humidity/climate that tend to cause fading are stored in the form of a database on the radio base station 20a side. In addition, the invariable data may include special information indicating that the mobile units 10a and 10b are located in a building or underground.

The radio base station 20a always observes these atmospheric conditions. Note that since no difference between atmospheric conditions due to distances is observed in the places where the mobile units 10a and 10b and radio base station 20a exist, the mobile units 10a and 10b execute no observation. If the observation result obtained by the radio base station 20a indicates that the observed condition matches a condition that tends to cause fading, the width of the hysteresis zone 41 is increased in accordance with the degree of the condition. This makes it possible to prevent redundant control operation due to fading.

The cell maps formed by the radio base stations 20a and 20b are reported to the higher rank station 30 and shared by the higher rank station 30. When, therefore, the mobile units 10a to 10c move across the cells 40a and 40b, processing is performed in accordance with the cell maps reported to the higher rank station 30.

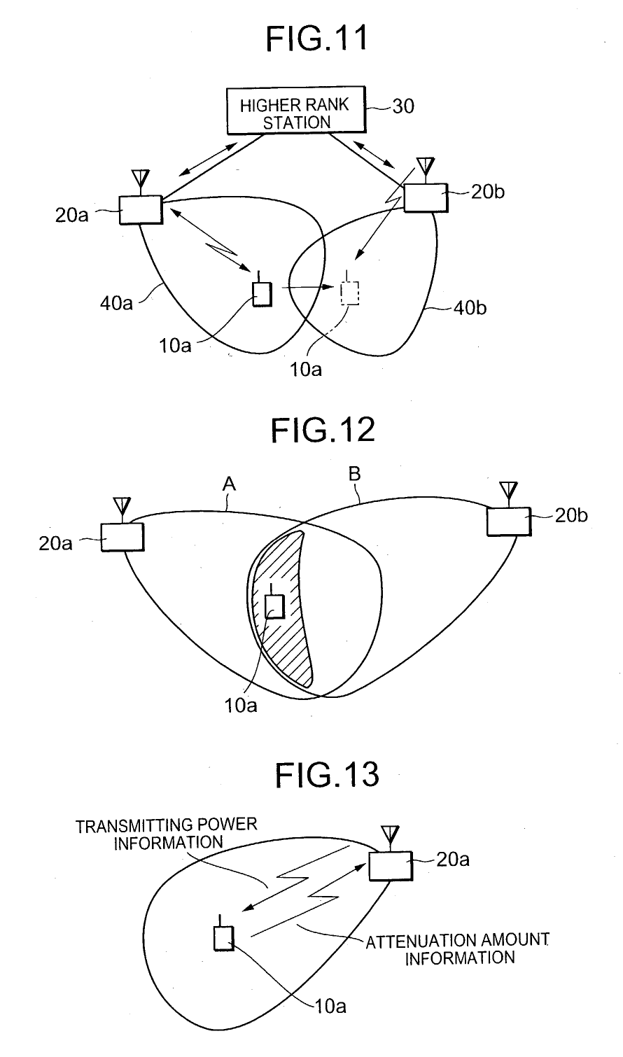

Processing to be performed when the mobile unit 10a moves from the cell 40a formed by the radio base station 20a into the cell 40b formed by the radio base station 20b in the mobile communication system of the present invention will be described below with reference to FIG. 11.

As shown in FIG. 11, since the cell maps formed by the radio base stations 20a and 20b are shared by the higher rank station 30, when the mobile unit 10a moves across the cells 40a and 40b, the cell maps reported to the higher rank station 30 are acquired by the radio base stations 20a and 20b and transmitted to the mobile unit 1a.

A method of estimating the positions of the mobile units 10a to 10c will be described below.

As a method of estimating the positions of the mobile units 10a to 10c, a method using combinations of sector codes and levels received from the mobile units 10a to 10c in the radio base stations 20a and 20b is conceivable.

FIG. 12 is a view for explaining a method of estimating the positions of the mobile units 1a to 10c in the mobile communication system of the present invention.

As shown in FIG. 12, in a place AB where signals transmitted from the two radio base stations 20a and 20b can be simultaneously received, the mobile unit 1a reports the scrambling code of a sector A formed by the radio base station 20a and the scrambling code of a sector B formed by the radio base station 20b to the radio base stations 20a and 20b. If the reception level of the scrambling code of the sector A is higher than that of the sector B, it is estimated that the mobile unit 10a is present in the hatched area in FIG. 12. This method increases in precision as the number of sectors that can be simultaneously monitored increases.

As another method of estimating the positions of the mobile units 10a to 10c, a method based on the transmission attenuation amounts of pilot channels, in the mobile units 10a to 10c, which are transmitted from the radio base stations 20a and 20b to the mobile units 10a to 10c, is conceivable.

FIG. 13 is a view for explaining still another method of estimating the positions of the mobile units 10a to 10c in the mobile communication system of the present invention.

Consider a system in which transmitting power information is transferred from the radio base stations 20a and 20b to the mobile units 10a to 10c, and the mobile units 10a to 10c calculate propagation attenuation amounts from the differences between the transmitting power information and reception power in the mobile units 10a to 10c, and report the propagation attenuation amounts in the mobile units 10a to 10c to the radio base stations 20a and 20b. As shown in FIG. 13, this system can estimate the positions of the mobile units 10a to 10c on the basis of the propagation attenuation amounts.

When a CDMA scheme is used as a communication scheme, power that reaches a radio base station is controlled to be constant during communication by a power control loop. Since information for this power control is contained in a communication channel, the distance from each of the mobile units 10a to 10c to a corresponding one of the radio base stations 20a and 20b can be estimated on the basis of this information.

The position information of the mobile units 10a to 10c, obtained by these methods, is registered on the network side through the radio base stations 20a and 20b.

Of the cell maps formed by the radio base stations 20a and 20b and reported to the higher rank station 30 in the above manner, portions corresponding to the positions of the mobile units 10a to 10c are transmitted to the mobile units 10a to 10c.

Upon reception of the transmitted cell maps, the mobile units 10a to 10c perform control to decrease the time and cycle for peripheral level measurement to be done during intermittent reception if they exist in areas where no cell handoff is required, thus reducing power consumption.

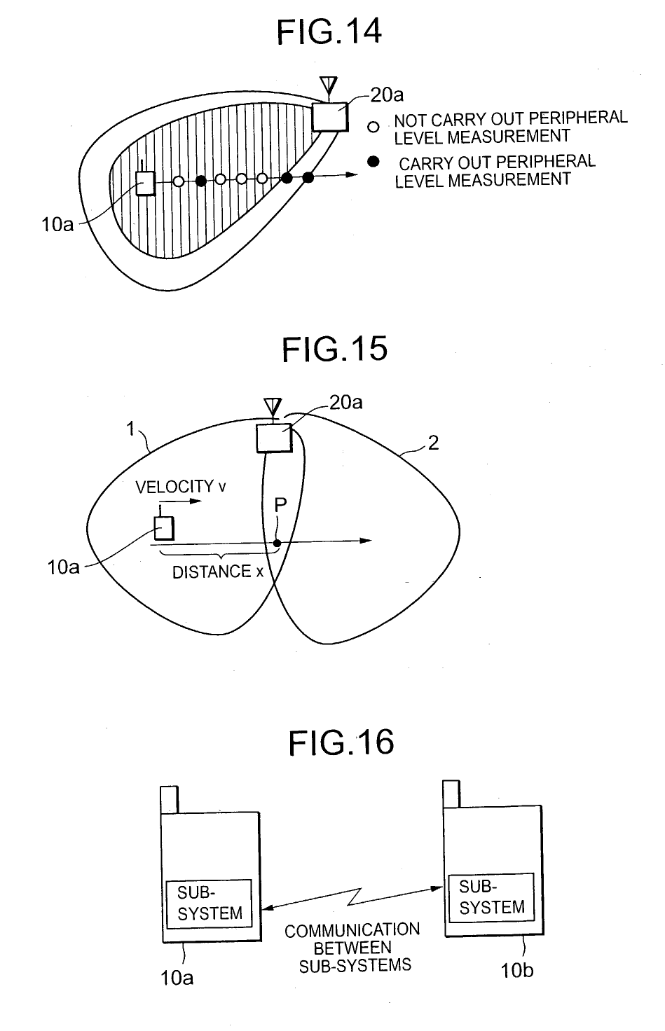

FIG. 14 is a view for explaining peripheral level measurement processing in the mobile unit 10a in the mobile communication system of the present invention.

As shown in FIG. 14, the mobile unit 10a performs control to decrease the time and cycle for peripheral level measurement to be done during intermittent reception if the unit exists in an area where no cell handoff is required.

When the mobile units 10a to 10c are to move at nearly constant velocities as moving on trains or driving on expressways, the times when sector handoffs should be done can be calculated in advance.

FIG. 15 is a view for explaining the processing to be performed when the mobile unit 10a moves at a nearly constant velocity in the mobile communication system of the present invention.

As shown in FIG. 15, when the mobile unit 10a is to move at a nearly constant velocity, a moving velocity v of the mobile unit 10a may be detected by some method (e.g., predicting it from a fading pitch), and a distance x to a sector handoff point A may be calculated in advance from the sector map. With this operation, a handoff procedure may be executed by the mobile unit 10a and radio base station 20a after a time of t=x/V.

This makes it possible to omit communication for a sector handoff procedure.

If ad-hoc systems (e.g., Bluetooth systems) with low power consumption are mounted in the mobile units 10a to 10c, and two of the mobile units 10a to 10c are located near each other, area maps can be exchanged by using the systems.

FIG. 16 is a view for explaining the processing to be performed when ad-hoc systems with low power consumption are mounted in the mobile units 10a and 10b in the mobile communication system shown in FIG. 5.

Assume that ad-hoc systems with low power consumption, such as Bluetooth systems, are mounted in the mobile units 10a and 10b in the mobile communication system of the present invention shown in FIG. 5. In this case, if the mobile units 10a and 10b are located near each other, they can exchange area maps by using the systems. The newer the obtained area maps, the longer the communication time intervals between the radio base stations 20a and 20b.

What is claimed is:

1. A mobile communication system including mobile units and a plurality of radio base stations which respectively form cells/sectors and communicate with said mobile units existing in the cells/sectors,
wherein said radio base station estimates a shape of the cell/sector formed by said radio base station on the basis of information transmitted from said mobile unit.

2. A system according to claim 1, wherein said mobile unit transmits, to said radio base station, information by which its position can be estimated.

3. A system according to claim 2, wherein said radio base station registers the position of said mobile unit on the basis of information transmitted from said mobile unit.

4. A system according to claim 1, further comprising a higher rank station which connects said plurality of radio base stations to each other, said radio base stations reporting the estimated shapes of the cells/sectors to said higher rank station.

5. A system according to claim 2, further comprising a higher rank station which connects said plurality of radio base stations to each other, said radio base stations reporting the estimated shapes of the cells/sectors to said higher rank station.

6. A system according to claim 3, further comprising a higher rank station which connects said plurality of radio base stations to each other, said radio base stations reporting the estimated shapes of the cells/sectors to said higher rank station.

7. A system according to claim 4, wherein said radio base station includes a hysteresis width in the shape of the cell/sector.

8. A system according to claim 5, wherein said radio base station includes a hysteresis width in the shape of the cell/sector.

9. A system according to claim 6, wherein said radio base station includes a hysteresis width in the shape of the cell/sector.

10. A system according to claim 2, wherein said radio base station estimates a shape of a cell/sector formed by said radio base station on the basis of a code determined for each of the sectors, which is transmitted from said mobile unit, and a reception level of the code.

11. A system according to claim 5, wherein said radio base station estimates a shape of a cell/sector formed by said radio base station on the basis of a code determined for each of the sectors, which is transmitted from said mobile unit, and a reception level of the code.

12. A system according to claim 8, wherein said radio base station estimates a shape of a cell/sector formed by said radio base station on the basis of a code determined for each of the sectors, which is transmitted from said mobile unit, and a reception level of the code.

13. A system according to claim 2, wherein said radio base station estimates a shape of a cell/sector formed by said radio base station on the basis of a transmission attenuation amount of a pilot channel in said mobile unit which is transmitted from said mobile unit.

14. A system according to claim 5, wherein said radio base station estimates a shape of a cell/sector formed by said radio base station on the basis of a transmission attenuation amount of a pilot channel in said mobile unit which is transmitted from said mobile unit.

15. A system according to claim 8, wherein said radio base station estimates a shape of a cell/sector formed by said radio base station on the basis of a transmission attenuation amount of a pilot channel in said mobile unit which is transmitted from said mobile unit.

16. A system according to claim 2, wherein said mobile unit estimates a position of said mobile unit on the basis of power control information transmitted from said radio base station, and transmits the position information to said radio base station, and said radio base station estimates a shape of a cell/sector formed by said radio base station on the basis of position information transmitted from said mobile unit.

17. A system according to claim 5, wherein said mobile unit estimates a position of said mobile unit on the basis of power control information transmitted from said radio base station, and transmits the position information to said radio base station, and said radio base station estimates a shape of a cell/sector formed by said radio base station on the basis of position information transmitted from said mobile unit.

18. A system according to claim 8, wherein said mobile unit estimates a position of said mobile unit on the basis of power control information transmitted from said radio base station, and transmits the position information to said radio base station, and said radio base station estimates a shape of a cell/sector formed by said radio base station on the basis of position information transmitted from said mobile unit.

19. A system according to claim 4, wherein said radio base station acquires a shape of a cell/sector reported to said higher rank station, and provides the acquired shape of the cell/sector to said mobile unit.

20. A system according to claim 5, wherein said radio base station acquires a shape of a cell/sector reported to said higher rank station, and provides the acquired shape of the cell/sector to said mobile unit.

21. A system according to claim 6, wherein said radio base station acquires a shape of a cell/sector reported to said higher rank station, and provides the acquired shape of the cell/sector to said mobile unit.

22. A system according to claim 4, wherein said mobile unit determines a frequency of processing to be performed when said mobile unit moves between cells/sectors on the basis of the shapes of the cells/sectors provided from said radio base station.

23. A system according to claim 5, wherein said mobile unit determines a frequency of processing to be performed when said mobile unit moves between cells/sectors on the basis of the shapes of the cells/sectors provided from said radio base station.

24. A system according to claim 6, wherein said mobile unit determines a frequency of processing to be performed when said mobile unit moves between cells/sectors on the basis of the shapes of the cells/sectors provided from said radio base station.

25. A system according to claim 4, wherein said mobile unit decreases a time and cycle for processing to be performed when said mobile unit moves between cells/sectors on the basis of the shapes of the cells/sectors provided from said radio base station.

26. A system according to claim 5, wherein said mobile unit decreases a time and cycle for processing to be performed when said mobile unit moves between cells/sectors on the basis of the shapes of the cells/sectors provided from said radio base station.

27. A system according to claim 6, wherein said mobile unit decreases a time and cycle for processing to be performed when said mobile unit moves between cells/sectors on the basis of the shapes of the cells/sectors provided from said radio base station.

28. A system according to claim 4, wherein said mobile unit decreases a time and cycle for processing to be performed when said mobile unit moves between cells/sectors, when determining that said mobile unit is moving at a constant velocity.

29. A system according to claim 5, wherein said mobile unit decreases a time and cycle for processing to be performed when said mobile unit moves between cells/sectors, when determining that said mobile unit is moving at a constant velocity.

30. A system according to claim 6, wherein said mobile unit decreases a time and cycle for processing to be performed when said mobile unit moves between cells/sectors, when determining that said mobile unit is moving at a constant velocity.

31. A system according to claim 19, wherein said mobile unit provides a shape of a cell/sector, provided from said radio base station, to another mobile unit.

32. A system according to claim 22, wherein said mobile unit provides a shape of a cell/sector, provided from said radio base station, to another mobile unit.

33. A system according to claim 25, wherein said mobile unit provides a shape of a cell/sector, provided from said radio base station, to another mobile unit.

34. A system according to claim 28, wherein said mobile unit provides a shape of a cell/sector, provided from said radio base station, to another mobile unit.

35. A system according to claim 7, wherein the hysteresis width is variable.

36. A system according to claim 8, wherein the hysteresis width is variable.

37. A system according to claim 9, wherein the hysteresis width is variable.

38. A system according to claim 35, wherein the variable hysteresis width is determined from variable data based on a season, temperature, or time and invariable data including topographical data.

39. A system according to claim 36, wherein the variable hysteresis width is determined from variable data based on a season, temperature, or time and invariable data including topographical data.

40. A system according to claim 37, wherein the variable hysteresis width is determined from variable data based on a season, temperature, or time and invariable data including topographical data.

41. A system according to claim 38, wherein the invariable data is determined while including special information indicating that said mobile unit is located in a building or underground.

42. A system according to claim 39, wherein the invariable data is determined while including special information indicating that said mobile unit is located in a building or underground.

43. A system according to claim 39, wherein the invariable data is determined while including special information indicating that said mobile unit is located in a building or underground.

44. A system according to claim 7, wherein said radio base station increases the hysteresis width under a condition in which fading tends to occur.

45. A system according to claim 8, wherein said radio base station increases the hysteresis width under a condition in which fading tends to occur.

46. A system according to claim 9, wherein said radio base station increases the hysteresis width under a condition in which fading tends to occur.
